(19) United States
(12) Patent Application Publication
(10) Pub. No.: US 2013/0344365 A1
(43) Pub. Date: Dec. 26, 2013

(54) Lithium Secondary Battery

(71) Applicants: Hiroshi Haruna, Tokyo (JP); Shingo Ito, Tokyo (JP)

(72) Inventors: Hiroshi Haruna, Tokyo (JP); Shingo Ito, Tokyo (JP)

(73) Assignee: Shin-Kobe Electric Machinery Co., Ltd., Chuo-ku, Tokyo (JP)

(21) Appl. No.: 14/003,378

(22) PCT Filed: Feb. 28, 2012
(86) PCT No.: PCT/JP2012/054920

§ 371 Date: Sep. 5, 2013

(30) Foreign Application Priority Data
Mar. 16, 2011 (JP) 2011-057559

(51) Int. Cl. H01M 10/04

(52) U.S. Cl. CPC H01M 10/0431
USPC 429/94

(57) ABSTRACT

The purpose of the present invention is to examine a novel core material for a lithium secondary battery and to provide a battery in which there is minimal variation from initial battery characteristics over time during long-term storage of the battery. In order to enhance the high-temperature storage characteristics of a lithium battery, a resin composed primarily of a cellulose-containing polypropylene is used as a winding core material.

### TECHNICAL FIELD

The present invention relates to a core used for a lithium secondary battery.

### BACKGROUND ART

In recent power sources for mobile communication such as mobile phones and mobile personal computers, reduction in size and increase of energy density have been demanded more and more, and development for power storage sources in combination with solar cells and window power generation has also been progressed. Meanwhile, electric cars and hybrid cars and hybrid trains utilizing electric power as a portion of driving power have also been put to practical use.

However, while LiPF₆ used generally for an electrolyte solution in non-aqueous lithium secondary batteries has high ionic conductivity and causes less side reaction even on electrode surfaces, thermal stability and resistance to hydrolysis are poor. Particularly, there has been known a problem of lowering a cell capacity upon reaction with a trace amount of water in the electrolyte solution, in which electrolysis products are deposited on the surface of electrodes to increase the internal resistance of the battery increases with time. Further, when an Mn type oxide is used as a positive electrode active material, hydrofluoric acid formed by heating and hydrolysis of LiPF₆ promotes leaching of Mn in the positive electrode material. When Mn is leached, the structure of the positive electrode material is sometimes collapsed to promote deterioration of battery performance. Then, various electrolytes have been proposed so far with an aim of improving the thermal stability and the resistance to hydrolysis. For example, LiBF₄, LiCF₃SO₃, Li (CF₃SO₂)₂N, LiClO₄, LiB(C₂O₄)₂, and LiBF₂(C₂O₄) have been known, but their battery characteristics are not sufficient for coping with high capacity and long life lithium secondary batteries in recent years, to result in problems such as low solubility to solvents for electrolytes lowering of ionic conductivity, deterioration of electrochemical stability in a high voltage atmosphere, and corrosion of aluminum current collectors.

For improving the battery characteristics, patent reference 1, for example, discloses the use of metals such as pure aluminum and stainless steel, and polymeric compounds such as PP for the material of the core on which a positive electrode, a negative electrode, and a separator are wound.

### CITATION LIST

### Patent Literature

Patent Literature 1: JP-A No. H09-92339

### SUMMARY OF THE INVENTION

### Technical Problem

The present invention has a subject of investigating new materials for a core of a lithium secondary battery instead of the core materials disclosed in the Patent literature 1 and providing a battery with less aging change from initial battery characteristics during long time storage of the battery.

One of the objects of the present invention is to provide a new core material in order to solve the subjects described above.

### Solution to Problem

Various new materials for a core have been investigated in order to solve the subjects described above.

As a result, it has been found that high temperature storage characteristics of a lithium secondary battery are improved by using a resin comprising a cellulose-containing polypropylene as a main ingredient for the material of a winding core.

Particularly, a lithium secondary battery using a resin core comprising a cellulose-containing polypropylene preferably having a tensile strength of 40 MPa or more is preferred.

Further, a lithium secondary battery using a resin core comprising a cellulose-containing polypropylene having a bending strength of 50 MPa or more is more preferred.

### Advantageous Effects of Invention

A lithium secondary battery of excellent high temperature storage characteristics can be obtained according to the present invention.

### BRIEF DESCRIPTION OF DRAWING

FIG. 1 is a schematic cross sectional view of a cylindrical lithium secondary battery according to the present invention.

### DESCRIPTION OF EMBODIMENTS

A cellulose-containing polypropylene resin used in the present invention is a thermoplastic resin reinforced with cellulose fibers for suppressing deformation and structural change at high temperature, compared with a case of using only propylene.

As a performance required for the core of the present invention, it is necessary that the core has a strength capable of supporting an electrode winding group and not reacting with an electrolyte which is an organic solvent in the inside of the battery.

Referring at first to a support for the electrode winding group, when a positive electrode, a negative electrode, and a separator are wound, weight of the electrode material is applied on the core by so much as the material is wound after starting winding of the electrode. Unless the rigidity of the core per se is ensured to some extent, the core cannot support the electrode winding group to cause distortion. When the winding group is distorted, since inter-electrode distance between the positive electrode and the negative electrode varies and the inter-electrode distance between the positive and negative electrodes is no more constant, this results in deterioration of battery characteristics such as lowering of capacity and increase of internal resistance of the battery. When the cellulose-containing polypropylene of the present invention is used, it provides advantages that various properties such as rigidity and tensile strength can be controlled according to the blending amount of the cellulose.

Further, if the core comprises a material reactive to an organic solvent in the inside of the battery, this causes structural change of the core as a support for the electrode winding group after injection of an electrolyte solution, thereby deteriorating the battery characteristics. Further, this induces contact between the positive electrode and the negative electrode to cause generation of internal short-circuit, which also deteriorates the battery safety.

While the mechanism for the function of the cellulose-containing polypropylene resin of the present invention has not yet been apparent, it has been known that the cellulose-containing reinforced polypropylene resin has a water absorbing effect. In the lithium secondary battery it is necessary to decrease water contained in the inside of the batteries as much as possible, for example, by the use of a non-aqueous electrolyte solution. Water, if present, inside the battery promotes decomposition of LiPF₆ having sensitive reactivity with water to deteriorate battery characteristics. It is considered that deterioration of the battery characteristics is suppressed even during long time test by using the cellulose-containing polypropylene resin. Particularly, it is considered that the effect is increased in a completely sealed type container which is considered to cause less water intrusion from the outside to the inside of a battery casing.

A non-aqueous electrolyte solution used in the present invention includes cyclic carbonates, chained carbonates, chained carboxylate esters, lactones, cyclic ethers, chained ethers, etc. A mixture of one or more of such materials is used as a solvent and a lithium salt is dissolved as a solute into the solvent. Specific Examples of the non-aqueous solvent include, for example, ethylene carbonate, propylene carbonate, γ-butyrolctone, dimethyl carbonate, ethyl methyl carbonate, and diethyl carbonate. Halides such as fluorine substitutes and sulfur substitutes of such solvents can also be used.

While the solvents can be used each alone or in admixture of two or more of them, a mixed solvent comprising a solvent of high viscosity such as a cyclic carbonate or a cyclic lactone and a solvent of low viscosity such as a chained carbonate or chained ester is preferred.

Specific examples of lithium salts as the solute include, for example, lithium salts such as LiPF₆, LiBF₄, LiClO₄, LiAsF₆, LiCF₃, Li(CF₃SO₂), Li(CF₃SO₂)₂N, and Li(C₂F₅SO₂)N. Such lithium salts can be used alone or two or more of them may be used in admixture.

Further, for improving the characteristics of a battery, film forming agents for negative electrode surface, protective film forming agents for positive electrode, anti-overcharge additives, flame retardant additives, self-extinguishing additives, etc. and additives for improving wettability of electrode and separator can also be added depending on the purpose.

Further, the positive electrode active material that reversibly stores/releases lithium used in the present invention includes layered compounds such as lithium cobaltate (LiCoO₂) and lithium nickelate (LiNiO₂), or those compounds substituted with one or more transition metals, lithium manganates, for example, Li₁₋ₓMn₂₋ₓO₄ (where x=0 to 0.33),

Li₁₊ₓMn_{2-x-y}M_{y}O₄ (where M includes at least one of metals selected from Ni, Co, Fe, Cu, Al, and Mg, x=0 to 0.33, and y=0 to 1.0, 2−x−y>0), LiMnO₄, LiMn₂O₄, LiMnO₂, LiMn₂₋ₓMₓO₂ (where M includes at least one of metals selected from Ni, Co, Fe, Cu, Al, and Mg, and x=0.01 to 0.1), Li₂Mn₃MO₉ (where M includes at least one of metals selected from Ni, Co, Fe, and Cu), or mixtures containing copper-Li oxide (Li₂CuO₂), disulfide compound, Fe₂(MoO₄)₃, etc., or mixtures of one or more of polyaniline, polypyrrole, and polythiophene, etc.

Further, the negative electrode active material that reversibly stores/releases lithium used herein includes natural graphite, graphitizable materials obtained from petroleum coke and coal pitch coke which are treated at a high temperature of 2500° C. or higher or treated at a temperature of about 2,000° C., meso-phase carbon, amorphous carbon, graphite having amorphous carbon coated on the surface, carbon material comprising natural graphite or artificial graphite in which crystallinity at the surface is modified by mechanical treatment, carbon fibers, metallic lithium, metals alloying with lithium, and materials supporting metal on the surface of silicon or carbon particles. The metals supporting the carbon material include metals selected from lithium, aluminum, tin, silicon, indium, gallium, and magnesium or alloys thereof. Further, such metals or oxides of the metals can be utilized as the negative electrode active material.

In the present invention, a lithium secondary battery is manufactured as described below. At first, the positive electrode material described above is mixed with a conductive material comprising a carbon material powder and a binder such as polyvinylidene fluoride (PVDF) to prepare a slurry. The mixing ratio of the conductive material to the positive electrode active material is preferably 5 to 20 wt %. In this case, the powder particles of the positive electrode active material are kneaded sufficiently so that the particles are dispersed uniformly in the slurry by using a mixer having stirring device such as a rotary blade.

The slurry mixed sufficiently as described above is coated on both surfaces of an aluminum foil of 15 to 25 μm thickness, for example, by a roll transfer type coating machine. After both surface coating, the slurry is dried under pressing to prepare an electrode plate of the positive electrode. The thickness of the coated electrode mix is preferably 50 to 250 μm. The negative electrode is prepared by using graphite, amorphous carbon, or a mixture thereof as an active material, mixing the material with a binder and, coating and pressing them in the same manner as the positive electrode. The thickness of the electrode mix is preferably 50 to 200 μm. In the case of the negative electrode, a copper foil of 7 to 20 μm is used as a current collector. The mixing ratio in the coating is, for example, preferably 90:10 by weight ratio for the negative electrode active material and the binder. If the ingredient of the binder is excessive, the internal resistance value increases and, on the other hand, if it is insufficient, this may possibly deteriorate storage stability and cycle life of the battery.

The positive electrode and the negative electrode are prepared by cutting coated electrodes each into a predetermined size, and a lead wire for leading current and a current collector ring as a current take out terminal are prepared by spot welding or ultrasonic welding. The present invention can be applied to a lithium secondary battery for a mobile body such as an automobile in which a plurality of lead wires can be provided when supply of a large current is required. Then, the electrodes are stacked with a separator comprising a heat resistant separator, etc. using polyethylene, polypropylene, non-woven fabric, and ceramic material being interposed between them, rolled into a cylindrical shape to form an electrode group and then contained in a cylindrical container. Alternatively, a bag-shaped separator may be used and electrodes may be contained therein and they are stacked successively and contained in a square container. Alternatively, an electrode group may be wound in a flat shape and contained in a square or elliptic container. As the material for the container, stainless steel or aluminum is preferably used. After containing the electrode group in a battery container, an electrolyte solution is injected and sealed. As the electrolyte solution, LiPF₆ dissolved as an electrolyte in a solvent such as ethylene carbonate (EC), propylene carbonate (PC), and dimethyl carbonate (DMC) is used preferably. The concentration of the electrolyte is preferably between 0.6 M and 1.5 M. Then, the electrolyte solution is injected and the battery container is tightly sealed to complete a battery.

Examples and comparative examples of the present invention are to be described below with further reference to specific examples but the present invention is not restricted to the range of the examples but may be appropriately modified within the range included in the explanation described above.

### EXAMPLE

Examples of the present invention are to be described with reference to the drawings.

### Example 1

Li_{1.02}Mn_{1.98}Al_{0.02}O₄ having an average particle diameter of 10 μm and a specific surface area of 1.5 m²/g was used as a positive electrode material. 85 wt % of a positive electrode material and a conductive agent formed by mixing vein graphite and acetylene black at 9:2 ratio were dispersed in an NMP solution of PVDF previously controlled to 5 wt % to form a slurry. The mixing ratio of the active material, the conductive agent, and PVDF was 85:10:5 by weight ratio. The slurry was coated substantially uniformly and homogeneously to an aluminum foil of 20 μm thickness (positive electrode current collector). After drying at a temperature of 80° C. after coating, it was coated on both surfaces of an aluminum foil by the same procedures. Then, they were compression molded by a roll press and cut into a coating width of 200 mm and a coating length of 5000 mm.

Further, a negative electrode was prepared by the following method. Natural graphite was used as a negative electrode active material, and the negative electrode active material and a solution of PVDF in NMP were mixed and sufficiently kneaded uniformly to prepare a negative electrode slurry. The mixing ratio of the negative electrode active material and PVDF was 90:10 by weight ratio. The slurry was coated substantially uniformly and homogeneously on a rolled copper foil of 10 μm thickness (negative electrode current collector). The slurry was coated and dried on both surfaces of the rolled copper foil by the same procedure as in the positive electrode. Then, they were compression molded by a roll press and cut into a coating width of 210 mm and a coating length of 5200 mm.

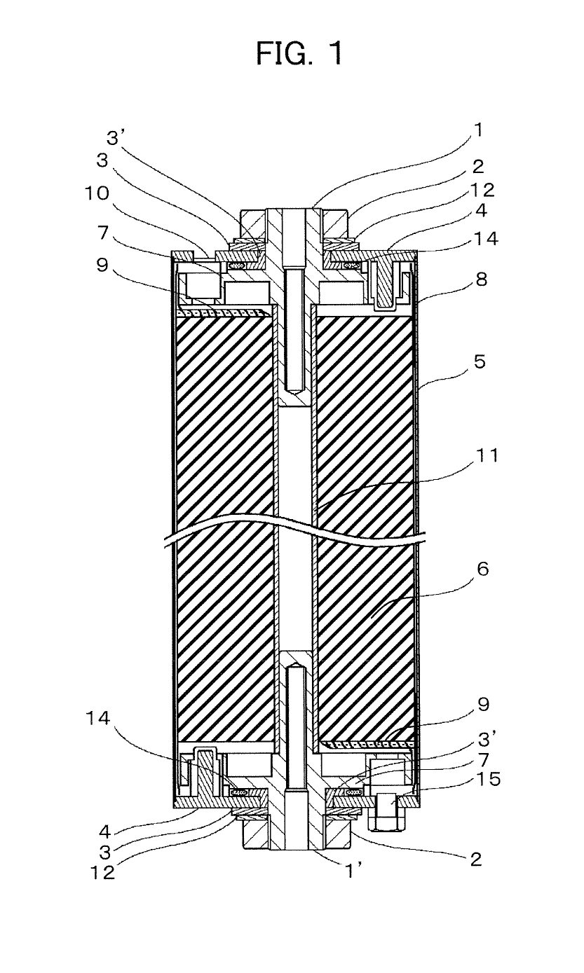

A cylindrical battery schematically illustrated in FIG. 1 was manufactured by using the prepared positive electrode plate and the negative electrode plate. The prepared positive electrode plate and the negative electrode plate were wound with a separator put between them so as not to be in direct contact each other around a core 11 comprising a cellulose-containing polypropylene resin having a tensile strength of 40 MPa and a bending strength of 57 MPa to prepare an electrode group. A lead piece 9 of the positive electrode and a lead piece 9 of the negative electrode were situated on both end faces of the electrode group opposite each other, so that the positive electrode mix coating portion did not protrude out of the negative mix coating portion. The tensile strength was measured by a method according to ISO 527 and the bending strength was measured by a method according to ISO 178 respectively.

The separator was a finely porous polyethylene film of 30 thickness and 5500 mm width. The electrode group was inserted into a battery container 5 made of SUS and the battery container and a battery lid were joined by laser welding.

As the electrolyte solution, LiPF₆ as an electrolyte was dissolved at a concentration of 1.0 mol/litter to a mixed solution prepared by mixing ethylene carbonate (EC) and ethyl methyl carbonate (EMC) at a ratio of EC:EMC=1:2 by weight. Then after injecting the prepared electrolyte solution through an injection hole 13, the injection hole was sealed. While taking care of avoiding contact between the electrode group 6 and the battery container 5 or between a positive battery external terminal 1 or a negative electrode external terminal 1′ each having a flange 7 and the electrode container, and with an aim of ensuring tight sealing of the battery, a battery lid 4 having a gas release valve 10, washers 3 and 3′ made of ceramics, an insulation coating treatment portion 8, metal washers 12, and O-rings 14 are provided by way of nuts 2.

In a thermostat bath at 25° C., constant current/constant voltage charge by a charging current of 50 A at a voltage of 4.2 V for 3 hours and constant current discharge at a discharging current of 50 A and a battery voltage up to 2.7 V were performed. Assuming such charge and discharge process as one cycle, the process was performed for three cycles. The discharge capacity at the third cycle was defined as an initial capacity and the ratio to 50 A ampere-hour capacity after a 60 days storage test was calculated. The battery was left in a thermostat bath under storage test conditions at 50° C. and at 4.2 V, and an ampere-hour capacity ratio before and after leaving was defined as storage characteristics.

Storage characteristics (%)=battery capacity after 60 days (Ah)/initial capacity (Ah)×100

### Example 2

Example 2 is a lithium secondary battery manufactured by the method described in Example 1 in which a cellulose-containing polypropylene resin having a tensile strength of 42 MPa and a bending strength of 70 MPa was used.

### Example 3

Example 3 is a lithium secondary battery manufactured by the method described in Example 1 in which a cellulose-containing polypropylene resin having a tensile strength of 37 MPa and a bending strength of 40 MPa was used.

### Comparative Example 1

Comparative Example 1 is a lithium secondary battery manufactured by the method described in Example 1 in which a glass filler-containing polypropylene resin having a tensile strength of 38 MPa and a bending strength of 57 MPa was used.

### Comparative Example 2

Comparative Example 2 is a lithium secondary battery manufactured by the method described in Example 1 in which a glass filler-containing polypropylene resin having a tensile strength of 48 MPa and a bending strength of 74 MPa was used.

TABLE 1

| | Property of material | | Storage |
|---|---|---|---|
| | Tensile | Bending | characteristics |
| | strength (MPa) | strength (MPa) | (%) |
| Example 1 | 40 | 57 | 80.6 |
| Example 2 | 42 | 70 | 82.1 |
| Example 3 | 37 | 40 | 84.9 |
| Comp. Example 1 | 38 | 57 | 76.3 |
| Comp. Example 2 | 48 | 74 | 79.6 |

Table 1 shows high temperature storage characteristics after 60 days for lithium secondary batteries manufactured according to the examples and the comparative examples. It has been found that high temperature storage characteristics can be improved by using the cellulose-reinforced polypropylene resin for the core. Further it has been found that the tensile strength is more preferably 40 MPa or more and the bending strength is more preferably 50 MPa or more.

This is considered that when the tensile strength and the bending strength of the core are low, the electrode group could not be maintained at a predetermined strength and a constant inter-electrode distance could not be maintained.

In view of the results described above, it has been found that the high temperature storage characteristics of the battery can be improved by using the cellulose-reinforced polypropylene.

### LIST OF REFERENCE SIGN

1 positive electrode external terminal
1′ negative electrode external terminal
2 nut
3 first ceramic washer
3′ second ceramic washer
4 battery lid
5 battery container
6 electrode group
7 flange
8 insulation cloth
9 lead piece
10 gas relief valve
11 core
12 metal washer
13 liquid injection hole
14 O-ring

1. A lithium secondary battery of a structure having an electrode winding group in which a strip-like positive electrode having a positive electrode active material capable of releasing and storing lithium by charge/discharge coated on a positive electrode current collector and a strip-like negative electrode having a negative electrode active material capable of storing/releasing lithium by charge/discharge coated on a negative electrode current collector are wound, around a core with a strip-like separator capable of permeating lithium ions therethrough being put between them, in which the electrode winding group is incorporated together with the core in a cylindrical battery container and supported or fixed in the battery container, wherein the material of the core comprise a cellulose-containing polypropylene as a main ingredient.

2. The lithium secondary battery according to claim 1, wherein the cellulose-containing polypropylene has a tensile strength of 37 MPa or more.

3. The lithium secondary battery according to claim 1, wherein the cellulose-containing polypropylene has a bending strength of 40 MPa or more.

4. The lithium secondary battery according to claim 2, wherein the cellulose-containing polypropylene has a bending strength of 40 MPa or more.
